(19) United States
(12) Patent Application Publication
(10) Pub. No.: US 2024/0256891 A1
(43) Pub. Date: Aug. 1, 2024

(54) SYSTEMS AND METHODS FOR FEDERATED LEARNING USING NON-UNIFORM QUANTIZATION

(71) Applicant: Toyota Motor Engineering & Manufacturing North America, Inc., Plano, TX (US)

(72) Inventors: Chianing Wang, Mountain View, CA (US); Yiyue Chen, Austin, TX (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/104,463

(22) Filed: Feb. 1, 2023

(51) Int. Cl. G06N 3/098

(52) U.S. Cl. CPC G06N 3/098

(57) ABSTRACT

A method for training a machine learning model in an edge node of a federated learning system is provided. The method includes inputting a data point into the machine learning model including parameters quantized based on a first quantization level to obtain an output, quantizing the output based on the first quantization level and a non-uniform quantization scheme, computing gradients with respect to parameters from a last layer to a first layer of the machine learning model based on the quantized output, quantizing the gradients based on a second quantization level and the non-uniform quantization scheme, and updating the machine learning model using the quantized gradients.

### TECHNICAL FIELD

The present disclosure relates to systems and methods for federated learning, more specifically, to systems and methods for federated learning using non-uniform quantization of parameters of a machine learning model during machine learning training.

### BACKGROUND

In vehicular technologies, such as object detection for vehicle cameras, the distributed learning framework is still under exploration. With the rapidly growing amount of raw data collected at individual vehicles, in the aspect of user privacy, the requirement of wiping out personalized, confidential information and the concern for private data leakage motivate a machine learning model that does not require raw data transmission. In the meantime, raw data transmission to the data center becomes heavier or even infeasible or unnecessary to transmit all raw data. Without sufficient raw data transmitted to the data center due to communication bandwidth constraints or limited storage space, a centralized model cannot be designed in the conventional machine learning paradigm. Federated learning, a distributed machine learning framework, is employed when there are communication constraints and privacy issues. The model training is conducted in a distributed manner under a network of many edge nodes (e.g., vehicles, mobile devices, etc.) and an edge server.

Although a federated learning system only transmits updates of local models instead of raw data between a server and edge nodes, the communication cost for uploading and downloading the parameters of models is still very high, especially for mobile edges because mobile edges have relatively unstable connection with a server. Moreover, the federated learning system usually has multiple iterations (i.e., runs/trails) between edge nodes and a centralized controller. In addition, the federated learning system increases the total uploading and downloading the parameters of models compared with a centralized machine learning system.

Another major challenge in a federated learning system results from the possible heterogeneity of decentralized data and edge node infrastructure resources. The edge node dataset may not be independent and identically distributed. The dataset in each edge node which is used for training might vary and proportional classes of images. Moreover, requiring all edge nodes locally train models with the same infrastructure resource is not practical. Edge nodes with less computation power are likely to be stragglers that dramatically increase total training time, and eventually delay iteration time because faster edge nodes always need to wait for slower edge nodes.

Accordingly, a need exists for federated learning that improves the performance of locally trained models at edge nodes in a federated learning network and controls communication costs among edge nodes and a server.

### SUMMARY

The present disclosure provides systems and methods for federated learning using non-uniform quantization of parameters of a machine learning model.

In one embodiment, a method for training a machine learning model in an edge node of a federated learning system is provided. The method includes inputting a data point into the machine learning model including parameters quantized based on a first quantization level to obtain an output, quantizing the output based on the first quantization level and a non-uniform quantization scheme, computing gradients with respect to parameters from a last layer to a first layer of the machine learning model based on the quantized output, quantizing the gradients based on a second quantization level and the non-uniform quantization scheme, and updating the machine learning model using the quantized gradients.

In another embodiment, a vehicle for training a machine learning model in a federated learning system is provided. The vehicle includes a controller programmed to: input a data point into the machine learning model including parameters quantized based on a first quantization level to obtain an output, quantize the output based on the first quantization level and a non-uniform quantization scheme, compute gradients with respect to parameters from a last layer to a first layer of the machine learning model based on the quantized output, quantize the gradients based on a second quantization level and the non-uniform quantization scheme, and update the machine learning model using the quantized gradients.

In another embodiment, a system for training a machine learning model in a federated learning system is provided. The system includes a server and a plurality of edge nodes. Each of the edge nodes includes a controller programmed to: input a data point into the machine learning model including parameters quantized based on a first quantization level to obtain an output, quantize the output based on the first quantization level and a non-uniform quantization scheme, compute gradients with respect to parameters from a last layer to a first layer of the machine learning model based on the quantized output, quantize the gradients based on a second quantization level and the non-uniform quantization scheme, and update the machine learning model using the quantized gradients.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts a system for federated learning using non-uniform quantization of parameters of a machine learning model, in accordance with one or more embodiments shown and described herewith;

FIG. 1B depicts an exemplary machine learning model used in federated learning, in accordance with one or more embodiments shown and described herewith;

FIG. 2 depicts a schematic diagram of a system for federated learning using non-uniform quantization of parameters of a machine learning model, according to one or more embodiments shown and described herein;

FIG. 3 depicts a flowchart for training a machine learning model using non-uniform quantization of parameters and gradients of the machine learning model, according to one or more embodiments shown and described herein;

FIG. 4A depicts an exemplary non-uniform quantization scheme, in accordance with one or more embodiments shown and described herewith;

FIG. 4B depicts an exemplary non-uniform quantization scheme, in accordance with one or more embodiments shown and described herewith;

FIG. 5A depicts accuracy of a simulated uniform quantization federated learning, in accordance with one or more embodiments shown and described herewith;

FIG. 5B depicts accuracy of a simulated non-uniform quantization federated learning, in accordance with one or more embodiments shown and described herewith; and

FIG. 6 depicts accuracy of simulated models aggregated using different schemes.

### DETAILED DESCRIPTION

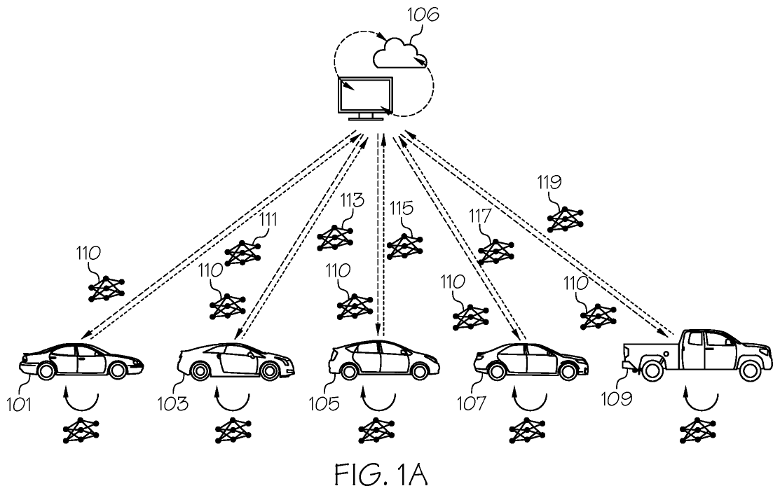

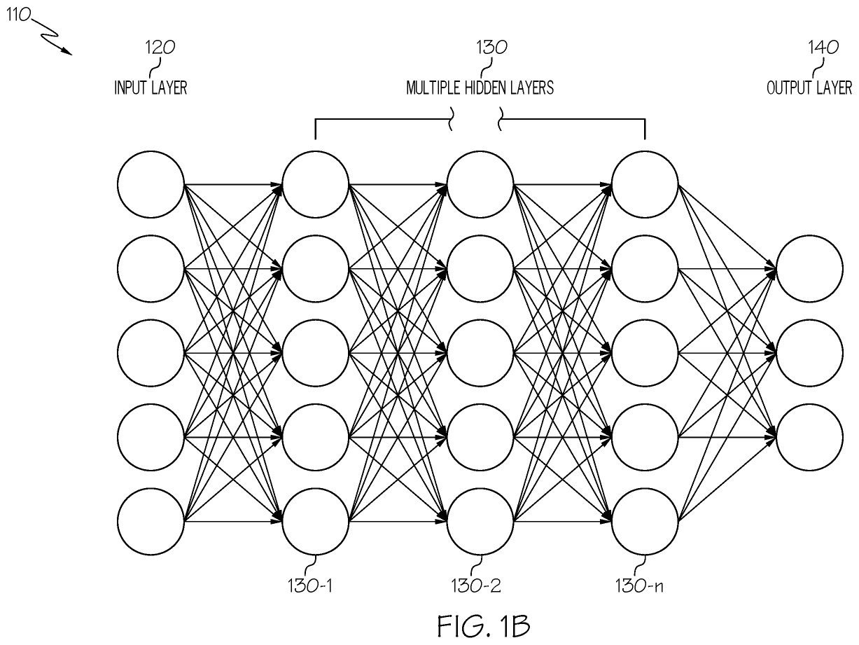

The embodiments disclosed herein include systems and methods for federated learning using non-uniform quantization of parameters of a machine learning model. According to the embodiments, a method for local training in an edge node in a federated learning system is provided. By referring to FIG. 1A, an edge node such as a vehicle 101 receives a machine learning model 110 from a server 106. The vehicle 101 collects local data e.g., images, using sensors such as cameras. Then, the vehicle 101 inputs the local data as a data point into the machine learning model 110. An example machine learning model 110 is illustrated in FIG. 1B. The data point is input to the input layer 120 of the machine learning model 110. The parameters of the machine learning model 110, i.e., the weights and/or biases of the machine learning model are quantized according to a first quantization level. The output of each of the hidden layers 130 is also quantized according to the first quantization level and a non-uniform quantization scheme.

Then, the vehicle 101 computes gradients with respect to parameters from a last layer 140 to a first layer 120 of the machine learning model 110 based on the quantized output and a cost function. The vehicle 101 quantizes the gradients based on a second quantization level and the non-uniform quantization scheme, and updates the machine learning model using the quantized gradient. Finally, the vehicle 101 quantizes the parameters of the updated machine learning model again and transmits the quantized parameters of the updated machine learning model to the server 106.

The non-uniform quantization according to the present disclosure not only compresses machine learning model parameters while transmitting the parameters between edge nodes and a server, but also quantizes weights and gradients of a machine learning model while implementing the federated learning's training. This significantly reduces required computing resources and communication costs. In addition, the non-uniform quantization increases the accuracy of a machine learning model compared to uniform quantization.

FIG. 1A schematically depicts a system for federated learning using non-uniform quantization of parameters of a machine learning model, in accordance with one or more embodiments shown and described herewith.

The system includes a plurality of edge nodes 101, 103, 105, 107, and 109, and a server 106. Training for a machine learning model 110 is conducted in a distributed manner under a network of the edge nodes 101, 103, 105, 107, and 109 and the server 106. The machine learning model may include an image processing model, an object perception model, an object classification model, or any other model that may be utilized by vehicles in operating the vehicles. The machine learning model may include, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. While FIG. 1A depicts five edge nodes, the system may include more than or less than five edge nodes. Edge nodes 101, 103, 105, 107, and 109 may have different datasets and different computing resources. The network bandwidth for a channel between each of the edge nodes 101, 103, 105, 107, 109 and the server 106 may be varied depending on communication conditions.

In embodiments, each of the edge nodes 101, 103, 105, 107, and 109 may be a vehicle, and the server 106 may be a centralized server or an edge server. The vehicle may be an automobile or any other passenger or non-passenger vehicle such as, for example, a terrestrial, aquatic, and/or airborne vehicle. The vehicle may be an autonomous vehicle that navigates its environment with limited human input or without human input. Each vehicle may drive on a road and perform vision-based lane centering, e.g., using a forward facing camera. Each vehicle may include actuators for driving the vehicle, such as a motor, an engine, or any other powertrain. In some embodiments, each of the edge nodes 101, 103, 105, 107, and 109 may be an edge server, and the server 106 may be a centralized server. In some embodiments, the edge nodes 101, 103, 105, 107, and 109 are vehicle nodes, and the vehicles may communicate with a centralized server such as the server 106 via an edge server.

In embodiments, the server 106 sends an initialized machine learning model 110 to each of the edge nodes 101, 103, 105, 107, and 109. The initialized machine learning model 110 may be any model that may be utilized for operating a vehicle, for example, an image processing model, an object detection model, or any other model for advanced driver assistance systems. Each of the edge nodes 101, 103, 105, 107, and 109 trains the received initialized machine learning model 110 using local data to obtain an updated machine learning model 111, 113, 115, 117, or 119 and sends the updated machine learning model 111, 113, 115, 117, or 119 or sends parameters of the updated machine learning model 111, 113, 115, 117, or 119 back to the server 106. The server 106 collects the updated machine learning models 111, 113, 115, 117, and 119, computes a global machine learning model based on the updated machine learning models 111, 113, 115, 117, and 119, and sends the global machine learning model to each of the edge nodes 101, 103, 105, 107, and 109 during a next run. Due to communication and privacy issues in vehicular object detection applications, such as dynamic mapping, self-driving, and road status detection, the federated learning framework can be an effective framework for addressing these issues in traditional centralized models. The edge nodes 101, 103, 105, 107, and 109 may be in different areas with different driving conditions. For example, some of the edge nodes 101, 103, 105, 107, and 109 are driving in a rural area, some are driving in a suburb, and some are driving in a city. In addition, the edge nodes 101, 103, 105, 107, and 109 may have different computing power and be equipped different types of sensors and/or different numbers of sensors.

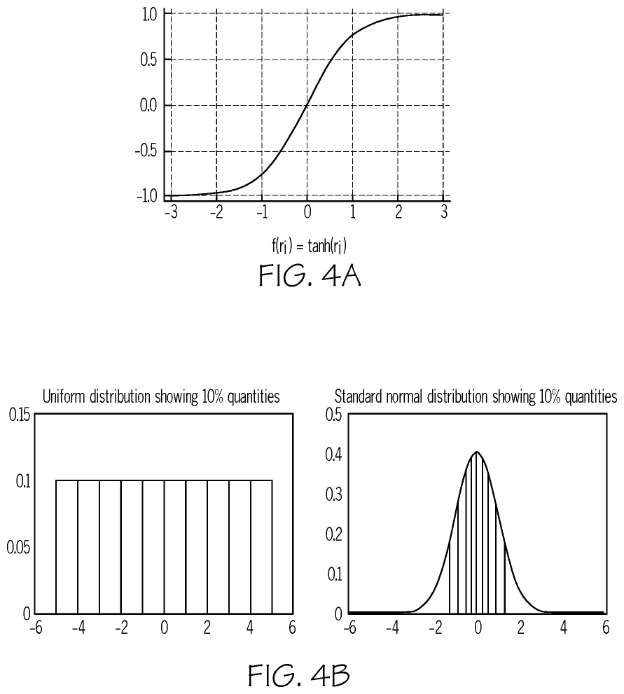

In embodiments, when training the machine learning model 110, each of the edge nodes 101, 103, 105, 107, and 109 may compress parameters and outputs of layers of the machine learning model 110. For example, the edge node 101 may train the machine learning model 110 as illustrated in FIG. 1B using local data. The machine learning model 110 includes parameters such as weights and/or biases for each of the layers of the machine learning model 110. The weights and/or biases may be quantized according to a first quantization level. The first quantization level may be determined based on at least one of a memory footprint of the edge node 101, a computation power of the edge node 101, and a communication bandwidth between the edge node 101 and the server 106. Then, the local data as a data point is input to the input layer 120 of the machine learning model 110. With the data point and the quantized weights and/or biases, the first hidden layer 130-1 of the hidden layers 130 outputs first layer output values. The first layer output values are similarly quantized based on the first quantization level and a non-uniform quantization scheme. The non-uniform quantization scheme will be described below with reference to FIGS. 4A and 4B. Then, the quantized first layer output values are input to the second hidden layer 130-2 to output second layer output values. The calculation continues until the output of the last layer or the output layer 140 is generated.

Then, the edge node 101 computes gradients with respect to parameters from a last layer, or the output layer 140 to a first layer or the input layer 120 of the machine learning model 110 based on the quantized output and a cost function. The cost function quantifies the difference between an expected output and the quantized output. The edge node 101 quantizes the gradients based on a second quantization level and the non-uniform quantization scheme. The second quantization level may be different from the first quantization level. The second quantization level may be determined based on at least one of a memory footprint of the edge node 101, and a computation power of the edge node 101. In determining the second quantization level, a communication bandwidth between the edge node 101 and the server 106 may not be considered. That is, the second quantization level may be purely determined by edge node constraints on local memory and computation. Then, the edge node 101 updates the machine learning model using the quantized gradients. Finally, the edge node 101 quantizes the parameters of the updated machine learning model again and transmits the quantized parameters of the updated machine learning model 111 to the server 106. Other edge nodes 103, 105, 107, and 109 similarly train the machine learning model 110 and transmit the quantized parameters of the updated machine learning models 113, 115, 117, and 119 to the server 106. The server 106 receives the quantized parameters of the updated machine learning models 111, 113, 115, 117, and 119 from the edge nodes 101, 103, 105, 107, and 109 and aggregates the quantized parameters of the updated machine learning models 111, 113, 115, 117, and 119 to form an aggregated global machine learning model. The server 106 may transmit the aggregated global machine learning model to each of the edge nodes 101, 103, 105, 107, and 109. Each of the edge nodes 101, 103, 105, 107 may drive autonomously using the aggregated global machine learning model. For example, each of the edge nodes 101, 103, 105, 107 may use the aggregated global machine learning to identify objects, classify the objects, and/or adjust vehicle parameters such as speeds, accelerations, directions of corresponding edge node.

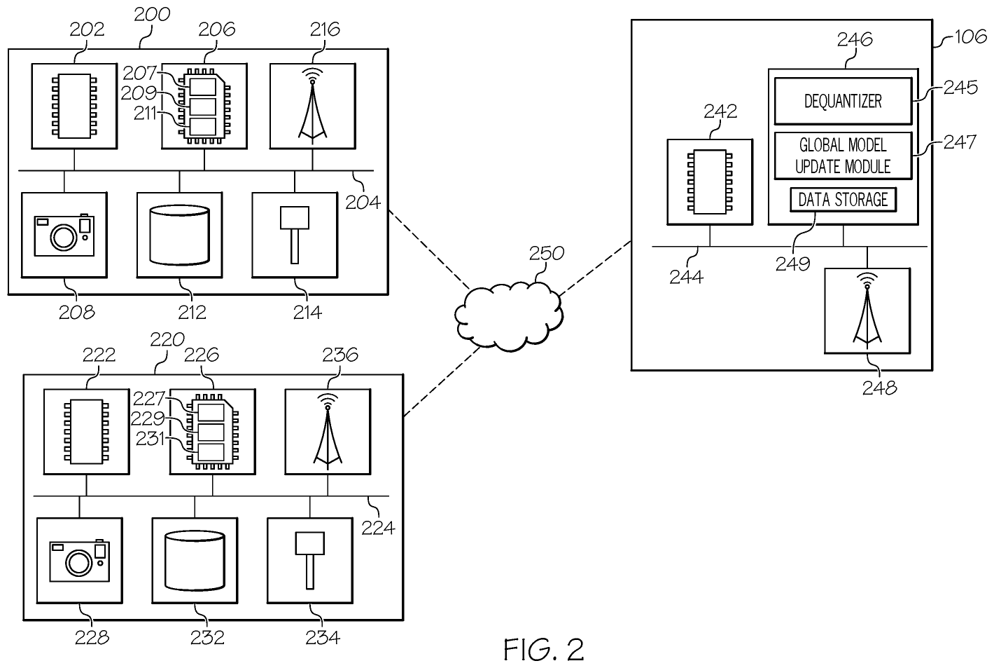

FIG. 2 depicts a schematic diagram of a system for federated learning using non-uniform quantization of parameters of a machine learning model, according to one or more embodiments shown and described herein. The system includes a first edge node system 200, a second edge node system 220, and the server 106. While FIG. 2 depicts two edge node systems, more than two edge node systems may communicate with the server 106.

It is noted that, while the first edge node system 200 and the second edge node system 220 are depicted in isolation, each of the first edge node system 200 and the second edge node system 220 may be included within a vehicle in some embodiments, for example, respectively within two of the edge nodes 101, 103, 105, 107, 109 of FIG. 1. In embodiments in which each of the first edge node system 200 and the second edge node system 220 is included within an edge node, the edge node may be an automobile or any other passenger or non-passenger vehicle such as, for example, a terrestrial, aquatic, and/or airborne vehicle. In some embodiments, the vehicle is an autonomous vehicle that navigates its environment with limited human input or without human input. In some embodiments, the edge node may be an edge server that communicates with a plurality of vehicles in a region and communicates with a centralized server such as the server 106.

The first edge node system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC), and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first edge node system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 202 along with the one or more memory modules 206 may operate as a controller for the first edge node system 200.

The one or more memory modules 206 includes a forward pass module 207, a backward pass module 209, and a model update module 211. Each of the forward pass module 207, the backward pass module 209, and the model update module 211 may include, but not limited to, routines, subroutines, programs, objects, components, data structures, and the like for performing specific tasks or executing specific data types as will be described below. Each of the forward pass module 207, the backward pass module 209, and the model update module 211 may be used for training the initial machine learning model received from the server 106.

The forward pass module 207 may train the initial machine learning model received from the server 106 using local data obtained by the first edge node system 200, for example, images obtained by imaging sensors such as cameras of a vehicle. The initial machine learning model may include, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. The forward pass module 207 quantizes the parameters of the initial machine learning model such as the machine learning model 110 in FIGS. 1A and 1B based on a first quantization level. For example, the first quantization level may be between 2 bit quantization and 5 bit quantization. Then, the forward pass module 207 feeds the local data as a data point into the machine learning model 110. The forward pass module 207 also quantizes the output of each layer of the machine learning model 110 based on the first quantization level and a non-uniform quantization scheme. The forward pass module 207 obtains the output of the last layer of the machine learning model 110 and quantizes the output of the last layer.

The backward pass module 209 may process backpropagation of the machine learning model 110 to compute gradients with respect to the parameters from the last layer 140 to the first layer 120 of the machine learning model 110 in FIG. 1B based on the quantized output calculated by the forward pass module 207. Specifically, the backward pass module 209 may obtain a cost function to quantify the difference between an expected output and the quantized output calculated by the forward pass module 207. Then, the backward pass module 209 computes gradients with respect to the parameters from the last layer 140 to the first layer 120 using the cost function. The backward pass module 209 quantizes the computed gradients based on a second quantization level and the non-uniform quantization scheme. The second quantization level may be different from the first quantization level. For example, the first quantization level may be 3 bit quantization and the second quantization level may be 4 bit quantization.

The model update module 211 may update the parameters of the machine learning model 110 using the quantized gradients generated by the backward pass module 209. For example, the model update module 211 may adjust the parameters of the machine learning model 110 using the quantized gradients such that the value of the cost function or loss is reduced. After the model update module 211 adjusted the parameters of the machine learning model 110, the model update module 211 quantizes the adjusted parameters of the machine learning model 110 based on a third quantization level, and transmits the quantized and adjusted parameters of the machine learning model 111 to the server 106.

Referring still to FIG. 2, the first edge node system 200 comprises one or more sensors 208. The one or more sensors 208 may include a forward facing camera installed in a vehicle. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data to the one or more processors 202 or another component communicatively coupled to the communication path 204. In some embodiments, the one or more sensors 208 may also provide navigation support. That is, data captured by the one or more sensors 208 may be used to autonomously or semi-autonomously navigate a vehicle.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar sensors may be used to obtain a rough depth and speed information for the view of the first edge node system 200.

The first edge node system 200 comprises a satellite antenna 214 coupled to the communication path 204 such that the communication path 204 communicatively couples the satellite antenna 214 to other modules of the first edge node system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first edge node system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of a vehicle, e.g., the edge node 101. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first edge node system 200 comprises network interface hardware 216 for communicatively coupling the first edge node system 200 to the second edge node system 220 and/or the server 106. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first edge node system 200 may transmit its data to the second edge node system 220 or the server 106. For example, the network interface hardware 216 of the first edge node system 200 may transmit vehicle data, location data, updated local model data and the like to the server 106.

The first edge node system 200 may connect with one or more external vehicle systems (e.g., the second edge node system 220) and/or external processing devices (e.g., the server 106) via a direct connection. The direct connection may be a vehicle-to-vehicle connection (“V2V connection”), a vehicle-to-everything connection (“V2X connection”), or a mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first edge node system 200 may be communicatively coupled to the server 106 by the network 250. In one embodiment, the network 250 may include one or more computer networks (e.g., a personal area network, a local area network, or a wide area network), cellular networks, satellite networks and/or a global positioning system and combinations thereof. Accordingly, the first edge node system 200 can be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second edge node system 220 includes one or more processors 222, one or more memory modules 226, one or more sensors 228, one or more vehicle sensors 232, a satellite antenna 234, and a communication path 224 communicatively connected to the other components of the second edge node system 220. The components of the second edge node system 220 may be structurally similar to and have similar functions as the corresponding components of the first edge node system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the communication path 224 corresponds to the communication path 204, the network interface hardware 236 corresponds to the network interface hardware 216, a forward pass module 227 corresponds to the forward pass module 207, a backward pass module 229 corresponds to the backward pass module 209, and a model update module 231 corresponds to the model update module 211).

Still referring to FIG. 2, the server 106 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242. The one or more memory modules 246 may include a dequantizer 245, a global model update module 247 and a data storage 249. Each of the dequantizer 245, the global model update module 247 and the data storage 249 may include, but is not limited to, routines, subroutines, programs, objects, components, data structures, and the like for performing specific tasks or executing specific data types as will be described below.

The dequantizer 245 may dequantize the quantized parameters of updated machine learning models received from edge nodes. For example, each of the first edge node system 200 and the second edge node system 220 may send the quantized parameters of an updated machine learning model to the server 106. The dequantizer 245 dequantizes the quantized parameters of an updated machine learning model received from each of the first edge node system 200 and the second edge node system 220.

The global model update module 247 generates an aggregated global model based on updated machine learning models received from edge nodes and transmits the aggregated global model to the edge nodes. Specifically, by referring to FIG. 1A, the server 106 receives quantized parameters of the updated machine learning models 111, 113, 115, 117, and 119 from the edge nodes 101, 103, 105, 107, and 109. The dequantizer 245 dequantizes the quantized parameters of the updated machine learning models 111, 113, 115, 117, and 119. The global model update module 247 aggregates dequantized parameters of the updated machine learning models 111, 113, 115, 117, and 119 to generate an aggregated global model. Specifically, the global model update module 247 determines weights for the updated machine learning models 111, 113, 115, 117, and 119 received from the edge nodes 101, 103, 105, 107, and 109. Then, the global model update module 247 may combine the updated machine learning models 111, 113, 115, 117, and 119 with the weights assigned to the updated machine learning models 111, 113, 115, 117, and 119. For example, the global model update module 247 may calculate weighted averages of the dequantized parameters of the updated machine learning models 111, 113, 115, 117, and 119 based on the determined weights.

The data storage 249 may store the updated machine learning models received from the edge nodes. The data storage 249 may also store an aggregated global model calculated by the global model update module 247.

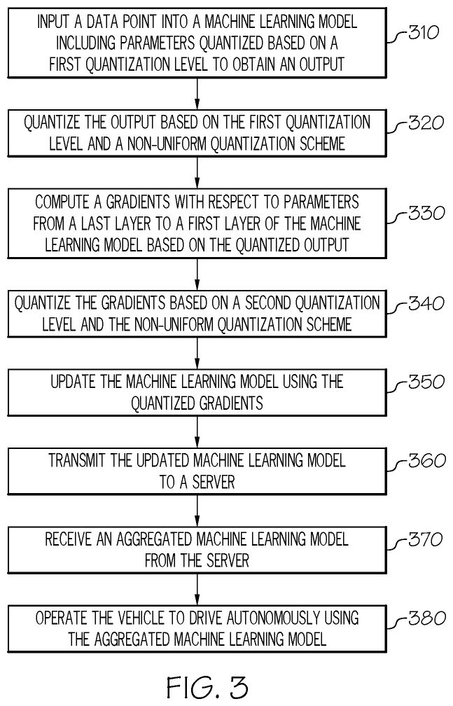

FIG. 3 depicts a flowchart for training a machine learning model using non-uniform quantization of parameters and gradients of the machine learning model, according to one or more embodiments shown and described herein.

In step 310, an edge node inputs a data point into a machine learning model including parameters quantized based on a first quantization level to obtain an output. For example, by referring to FIGS. 1A and 1B, the edge node 101 obtains local data using its sensors and inputs the local data as the data point into a machine learning model 110 to obtain an output. The parameters of the machine learning model 110 were quantized based on the first quantization before the data point is input into the machine learning model 110.

By referring back to FIG. 3, in step 320, the edge node quantizes the output based on the first quantization level and a non-uniform quantization scheme. Various non-uniform quantization schemes may be used to quantize the output. For example, a non-uniform quantization scheme illustrated in FIG. 4A may be utilized. quantizeₖ is a function that quantizes a real number input rᵢ ∈[0, 1] to a k-bit number output rₒᵤₜ∈[0, 1]. The quantization function is:

$${r}_{out} = 2 {quantize}_{k} ( \frac{tanh ( {r}_{i} )}{2 max ( \vert tanh ( {r}_{i} ) \vert )} + \frac{1}{2} ) - 1 \qquad Equation ( 1 )$$

As illustrated in FIG. 4A, the non-uniform quantization scheme leverages hyperbolic tangent function (tanh) to rescale the input parameter between [−1, 1]. Values between [−1, 1] are less squeezed than those outside the range. Then, the parameter is restricted into [0, 1] to facilitate further operations.

Another non-uniform quantization scheme is illustrated in FIG. 4B. This non-uniform quantization scheme determines the quantization level by quantile levels. For example, if parameters are quantized into 4 values (i.e., 2-bit quantization), the non-uniform quantization scheme finds the midpoint of each quartile range to be the quantization values.

By referring back to FIG. 3, in step 330, the edge node computes gradients with respect to parameters from a last layer to a first layer of the machine learning model. Specifically, the edge node may obtain a cost function to quantify the difference between an expected output and the quantized output calculated in step 320. Then, the edge node computes gradients with respect to the parameters from the last layer 140 to the first layer 120 of the machine learning model using the cost function.

In step 340, the edge node quantizes the gradients based on a second quantization level and the non-uniform quantization scheme. The second quantization level is determined based on at least one of a memory footprint of the edge node, and a computation power of the edge node.

In step 350, the edge node updates the machine learning model using the quantized gradient. For example, the edge node may adjust the parameters of the machine learning model 110 using the quantized gradients such that the value of the cost function or loss is reduced. After the parameters of the machine learning model 110 are adjusted, the edge node quantizes the adjusted parameters of the machine learning model 110 based on a third quantization level. The third quantization level may be the same as or different from the first quantization level. The third quantization level may be determined based on at least one of a memory footprint of the edge node 101, a computation power of the edge node 101, and a communication bandwidth between the edge node 101 and the server 106

In step 360, the edge node transmits the updated machine learning model to a server. Specifically, the edge node may transmit the quantized and adjusted parameters of the machine learning model 111 to the server 106.

In step 370, the edge node receives an aggregated machine learning model from the server. As described above, the server 106 receives quantized and adjusted parameters of machine learning models from a plurality of edge nodes, dequantizes the quantized parameters, aggregates the dequantized parameters to obtain an aggregated machine learning model, and transmit the aggregated machine learning model to each of the edge nodes.

In step 380, the edge node operates the vehicle to drive autonomously using the aggregated machine learning model. For example, the edge node may use the aggregated global machine learning to identify objects, classify the objects, or adjust vehicle parameters such as speeds, accelerations, directions of the vehicle.

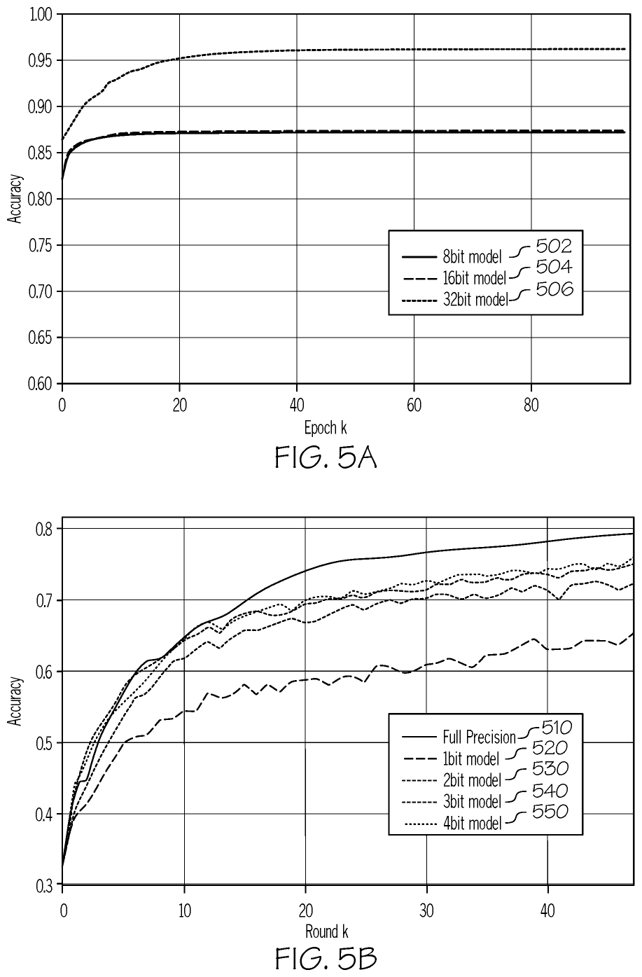

FIG. 5A depicts accuracy of a simulated uniform quantization federated learning. In this simulation, a federated learning system consists of a network with 10 edge nodes or clients. Each of the edge nodes has 2,000 images for local training. The local model is a convolutional neural network with 3 hidden layers. The parameters of the convolutional neural network are uniformly quantized. The convolutional neural network is implemented with 1-bit weights, and model updates rely on n-bit representations/computation.

As illustrated in FIG. 5A, an accuracy gap exists between a 32 bit quantization model 506 and 8 bit and 16 bit quantization models 504 and 506. In addition, the 8 bit quantization model 502 is preferable over the 16 bit quantization model 504 because the 8 bit quantization model 502 shows almost the same accuracy as the 16 bit quantization model 504 with using less data than the 16 bit quantization model 504.

FIG. 5B depicts accuracy of a simulated non-uniform quantization federated learning. In this simulation, a federated learning system consists of a network with 5 edge nodes or clients. The local model is a convolutional neural network with three hidden layers and a CIFAR10 dataset is used. The parameters of the local model, e.g., weights and gradients, are quantized using a non-uniform quantization scheme. Varied numbers of bits are used to quantize the weights of the local machine learning model. Gradients are quantized using 6 bits.

As illustrated in FIG. 5B, when a non-uniform quantization scheme is used for quantizing the weights and gradients, the accuracy rate improves compared to when a uniform quantization scheme is used. Specifically, 3 bit quantization model 540 or 4 bit quantization model 550 can align with a full precision model 510 (i.e., a 32 bit quantization model). In contrast, as illustrated in FIG. 5A, when a uniform quantization scheme is used, the 8 bit quantization model 502 or the 16 bit quantization model 504 still has gap with the full precision model, or the 32 bit quantization model 506.

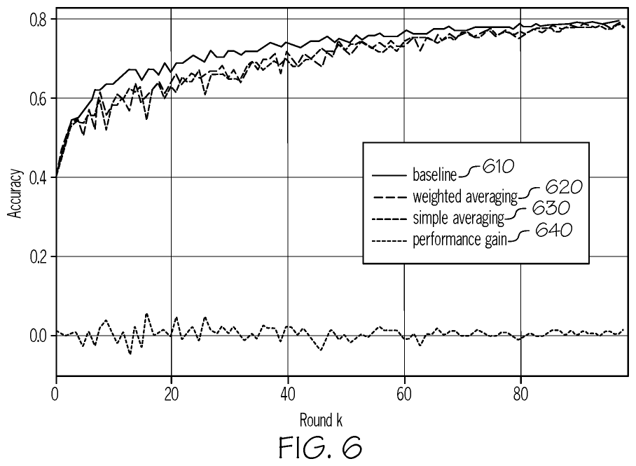

FIG. 6 depicts accuracy of simulated models aggregated using different schemes. This simulation includes a network with 5 edge nodes deploying 3, 4, 4, 4 and 5-bit models, respectively. A server combines local updates either by simple averaging or weighted averaging. The simple average is formed by assigning the same weights to each client. Weighted averaging is formed by setting weights proportional to x\hat{ }2 where x denotes the number of bits used for a local model. Weighted averaging here achieves a minor gain (0.2% in the last 20 rounds) over simple averaging. The gain may differ for more heterogeneous sets of clients.

It should be understood that embodiments described herein are directed. In embodiments, a method for local machine model training in an edge node is provided. The method includes inputting a data point into a machine learning model including parameters quantized based on a first quantization level to obtain an output, quantizing the output based on the first quantization level and a non-uniform quantization scheme, computing gradients with respect to parameters from a last layer to a first layer of the machine learning model based on the quantized output, quantizing the gradients based on a second quantization level and the non-uniform quantization scheme, and updating the machine learning model using the quantized gradients.

The non-uniform quantization according to the present disclosure not only compresses machine learning model parameters while transmitting the parameters between edge nodes and a server, but also quantizes weights and gradients of a machine learning model while doing the federated learning's training. The significant difference between uniform and non-uniform quantization is that uniform quantization has equal step sizes, while, in non-uniform quantization, the step sizes are not equal and vary based on local client infrastructure resources, e.g., processors or memories.

In non-uniform quantization, the step size is unequal. After the quantization, the difference between an input value and its quantized value is called the quantization error. In uniform quantization, the step size is equal. Therefore, some parts of the signal might not cover, increasing quantization error. However, in the case of non-uniform quantization according to the present disclosure, the step size changes. Thus, a machine learning model trained using non-uniform quantization scheme has less error than a machine learning model trained using a uniform quantization scheme.

Uniform quantization best suits the uniform distribution, where the model parameter distribution is assumed to have the same probability for taking all possible values. While this quantization method can be easily studied and implemented, it does not fit into most practical model parameter distributions that are usually non-uniform, e.g., Gaussian distribution or Laplacian distribution. For the one-dimensional Gaussian distributions, when the range between the quantization levels is equally taken, e.g., the step sizes are the same, the values near the mean (with higher probability) will be only represented using a few quantization levels while the values in the tails will waste bits for representation on values with much smaller probability. Therefore, the quantization error increases. However, the non-quantization according to the present disclosure better adapts the quantization levels to the distribution of model parameters so that the quantization error could be reduced.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for training a machine learning model in an edge node of a federated learning system, the method comprising:
inputting a data point into the machine learning model including parameters quantized based on a first quantization level to obtain an output;
quantizing the output based on the first quantization level and a non-uniform quantization scheme;
computing gradients with respect to parameters from a last layer to a first layer of the machine learning model based on the quantized output;
quantizing the gradients based on a second quantization level and the non-uniform quantization scheme; and
updating the machine learning model using the quantized gradients.

2. The method according to claim 1, wherein the first quantization level is determined based on at least one of a memory footprint of the edge node, a computation power of the edge node, and a communication bandwidth between the edge node and a server.

3. The method according to claim 1, wherein the second quantization level is determined based on at least one of a memory footprint of the edge node, and a computation power of the edge node.

4. The method according to claim 1, wherein the edge node is a vehicle, and the method further comprises:
transmitting the updated machine learning model to a server;
receiving an aggregated machine learning model from the server; and
operating the vehicle to drive autonomously using the aggregated machine learning model.

5. The method according to claim 1, wherein the edge node is an edge server, and
the method further comprises:
transmitting the updated machine learning model to a cloud server;
receiving an aggregated machine learning model from the cloud server; and
transmitting the aggregated machine learning model to one or more vehicles.

6. The method according to claim 1, wherein the machine learning model is a convolutional neural network.

7. The method according to claim 1, wherein the non-uniform quantization scheme quantizes the output based on quantile values.

8. The method according to claim 1, further comprising:
quantizing parameters of the updated machine learning model according to a third quantization level; and
transmitting the quantized parameters of the updated machine learning model to a server.

9. A vehicle for training a machine learning model in a federated learning system, comprising:
a controller programmed to:
input a data point into the machine learning model including parameters quantized based on a first quantization level to obtain an output;
quantize the output based on the first quantization level and a non-uniform quantization scheme;
compute gradients with respect to parameters from a last layer to a first layer of the machine learning model based on the quantized output;
quantize the gradients based on a second quantization level and the non-uniform quantization scheme; and
update the machine learning model using the quantized gradients.

10. The vehicle according to claim 9, wherein the first quantization level is determined based on at least one of a memory footprint of the vehicle, a computation power of the vehicle, and a communication bandwidth between the vehicle and a server.

11. The vehicle according to claim 9, wherein the second quantization level is determined based on at least one of a memory footprint of the vehicle, and a computation power of the vehicle.

12. The vehicle according to claim 9, wherein the controller is further programmed to:
transmit the updated machine learning model to a server;
receive an aggregated machine learning model from the server; and
operate the vehicle to drive autonomously using the aggregated machine learning model.

13. The vehicle according to claim 9, wherein the machine learning model is a convolutional neural network.

14. The vehicle according to claim 9, wherein the non-uniform quantization scheme quantizes the output based on quantile values.

15. The vehicle according to claim 9, wherein the controller is further programmed to:
quantize parameters of the updated machine learning model according to a third quantization level; and
transmit the quantized parameters of the updated machine learning model to a server.

16. A system for training a machine learning model in a federated learning system, the system comprising:
a server; and
a plurality of edge nodes, each of the edge nodes comprising:
a controller programmed to:
input a data point into the machine learning model including parameters quantized based on a first quantization level to obtain an output;
quantize the output based on the first quantization level and a non-uniform quantization scheme;
compute gradients with respect to parameters from a last layer to a first layer of the machine learning model based on the quantized output;
quantize the gradients based on a second quantization level and the non-uniform quantization scheme; and
update the machine learning model using the quantized gradients.

17. The system according to claim 16, wherein the first quantization level is determined based on at least one of a memory footprint of the edge node, a computation power of the edge node, and a communication bandwidth between the edge node and a server.

18. The system according to claim 16, wherein the second quantization level is determined based on at least one of a memory footprint of the edge node, and a computation power of the edge node.

19. The system according to claim 16, wherein the plurality of edge nodes are a plurality of edge servers.

20. The system according to claim 19, wherein each of the plurality edge servers communicate with a plurality of vehicles, and
each of the plurality of vehicles includes a controller programmed to train another machine learning model received from corresponding edge server.
